(19) United States
(12) Patent Application Publication
(10) Pub. No.: US 2025/0383773 A1
(43) Pub. Date: Dec. 18, 2025

(54) PRE-READ ALGORITHM FOR A SEQUENTIAL READ OPERATION OF A MEMORY SYSTEM

(71) Applicant: Micron Technology, Inc., Boise, ID (US)

(72) Inventors: Xiongjian Wu, Shanghai (CN); Feng Xu, Shanghai (CN); Lingyun Wang, Shanghai (CN)

(21) Appl. No.: 19/227,353

(22) Filed: Jun. 3, 2025

Related U.S. Application Data
(60) Provisional application No. 63/659,234, filed on Jun. 12, 2024.

(51) Int. Cl. G06F 3/06

(52) U.S. Cl. CPC G06F 3/0611; G06F 3/0659; G06F 3/0679

(57) ABSTRACT

Methods, systems, and devices for a pre-read algorithm for a sequential read operation of a memory system are described. In response to executing a first command indicating to read a first set of data, the memory system may store a second set of data in a buffer. The buffer may include multiple portions and a subset of the second set of data may be stored in a first portion of the multiple portions. Further, the memory system may set a value of a flag associated with the first portion to indicate that the subset of the second set of data has been transferred to the first portion. Moreover, the memory system may receive a third command to read the subset of the second set of data and transmit the subset of the second set of data based on the third command and the value of the flag.

### CROSS REFERENCE

The present application for patent claims priority to U.S. Patent Application No. 63/659,234 by Wu et al., entitled “PRE-READ ALGORITHM FOR A SEQUENTIAL READ OPERATION OF A MEMORY SYSTEM,” filed Jun. 12, 2024, which is assigned to the assignee hereof, and which is expressly incorporated by reference in its entirety herein.

### TECHNICAL FIELD

The following relates to one or more systems for memory, including a pre-read algorithm for a sequential read operation of a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports a pre-read algorithm for a sequential read operation of a memory system in accordance with examples as disclosed herein.

FIG. 2 shows an example of a system that supports a pre-read algorithm for a sequential read operation of a memory system in accordance with examples as disclosed herein.

FIG. 3 shows an example of a flow diagram that supports a pre-read algorithm for a sequential read operation of a memory system in accordance with examples as disclosed herein.

FIG. 4 shows a block diagram of a memory system that supports a pre-read algorithm for a sequential read operation of a memory system in accordance with examples as disclosed herein.

FIG. 5 shows a flowchart illustrating a method or methods that support a pre-read algorithm for a sequential read operation of a memory system in accordance with examples as disclosed herein.

### DETAILED DESCRIPTION

In some examples, a memory system may include one or more command queues. The memory system may receive one or more commands from a host system and store the one or more commands in one of the one or more command queues. The command queue may organize the one or more commands and issue the one or more commands to the memory system in a certain order (e.g., first-in first-out (FIFO)). Once the memory system executes a command in the command queue, the command queue may remove the command from the command queue and issue the next command in the command queue.

In some examples, the memory system may operate using a command queue with a queue depth of one. The queue depth may specify a quantity of commands that may be stored in the command queue. Thus, a command queue with a queue depth of one may be configured to store one command. However, using a command queue with a queue depth of one, the memory system must wait until after a single command is executed before adding a new command to the command queue, which may cause a delay (e.g., increasing host turnaround time) between removing the command from the command queue and adding the new command to the command queue.

During this delay, the memory system may experience an idle window or a period of inactivity or suboptimal activity. To increase efficiency, the memory system may perform one or more operations during the idle window. For example, the memory system may perform a pre-read operation. During the pre-read operation, the memory system may utilize a prediction scheme to pre-read data from a memory device of the memory system to a buffer of the memory system such that the data is ready to be transferred to the host system upon receiving a command to read the data.

In some examples, the host system may perform a sequential read operation. During the sequential read operation, the host system may transmit read commands to the memory system that correspond to sequential data. For example, the host system may transmit a first read command to the memory system as part of the sequential read operation. Upon identifying that the first read command corresponds to the sequential read operation and during the idle window following execution of the first read command, the memory system may perform a pre-read operation and store sequential data corresponding to the sequential read operation in the buffer of the memory system.

At another time, the memory system may receive a second read command from the host system. Upon identifying that the second read command is part of the sequential read operation, the memory system may poll a status of the buffer and determine whether (e.g., that) a portion of the sequential data corresponding to the second read command is ready for transfer. Further, the memory system may transfer the data to the host system. However, polling the status of the buffer may introduce latency into the data transfer, among other challenges.

As described herein, the memory system may decrease data transfer latency associated with a pre-read operation by triggering monitoring, such as automatic monitoring, of a ready status corresponding to the data in the buffer. In some examples, the memory system may receive a first read command from the host system and store the first read command in a command queue of the memory system. The first read command may indicate to read a first set of data from a memory device of the memory system. Upon executing the first read command, the memory system may read a second set of data from the memory device and store the second set of data in a buffer of the memory system (or perform a pre-read operation). In some examples, the buffer may include multiple portions and a first portion of the multiple portions may store at least a subset of the second set of data.

Further, the memory system may monitor the multiple portions of the buffer and set a value of a flag associated with the first portion to indicate that the at least subset of the second set of data has been transferred from the memory device to the first portion of the buffer. The memory system may then receive a second read command indicating to read the at least subset of the second set of data, identify the value of the flag, and transfer the second set of data from first portion of the buffer to the host system. The method as described herein may allow a memory system to transfer pre-read data from a buffer of the memory system without performing polling which may decrease latency of the transfer of the pre-read data.

In addition to applicability in memory systems as described herein, an algorithm for a sequential read operation of a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, among other benefits.

Features of the disclosure are illustrated and described in the context of systems, devices, and circuits. Additional aspects of the disclosure are illustrated and described in the context of a flow diagram and a process.

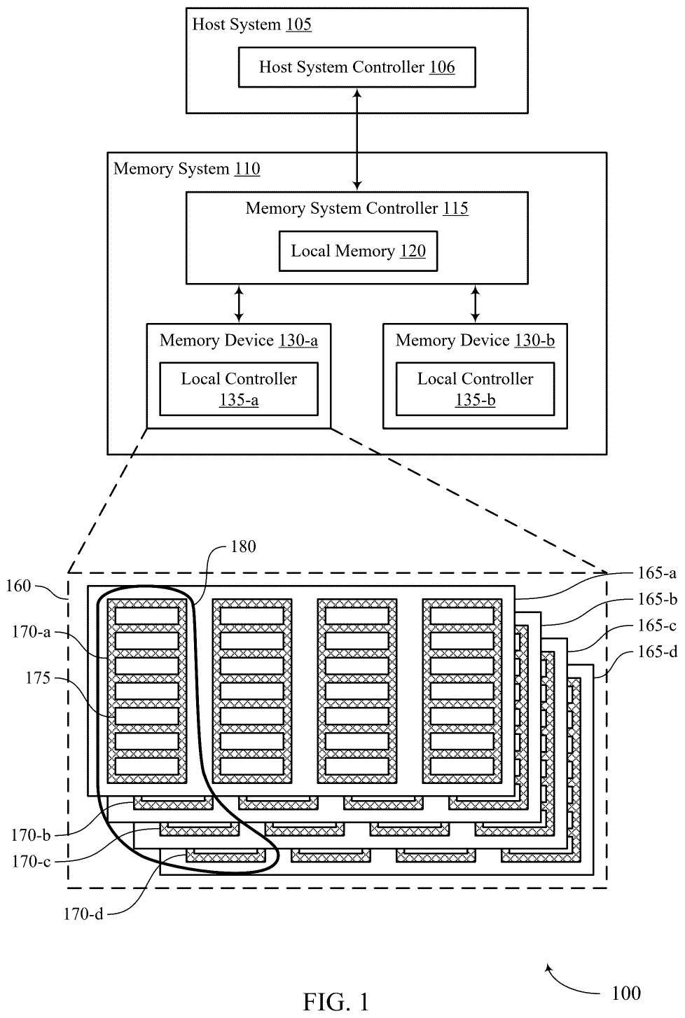

FIG. 1 shows an example of a system 100 that supports a pre-read algorithm for a sequential read operation of a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support a pre-read algorithm for a sequential read operation of a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

As described herein, a memory system may reduce a data transfer latency associated with a pre-read operation by automatically monitoring for a ready status of pre-read data in a buffer. In some examples, a memory system 110 may store a first command in a command queue that indicates for the memory system 110 to read a first set of data from one or more memory devices 130 of the memory system 110. Further, the memory system controller 115 may transmit a second command to the one or more memory devices 130 that indicates to retrieve a second set of data and store the second set of data in a buffer (e.g., a pre-read buffer) of the memory system 110. In some examples, the buffer includes multiple portions and a subset of the second set of data may be stored in a first portion of the multiple portions. Further, the memory system controller 115 may set a value of a flag associated with the first portion to indicate that the subset of the second set of data has been transferred to the first portion. Moreover, the memory system 110 may receive, from the host system 105, a third command to read the subset of the second set of data and in response to the third command and the value of the flag, transmit the subset of the second set of data to a host system 105.

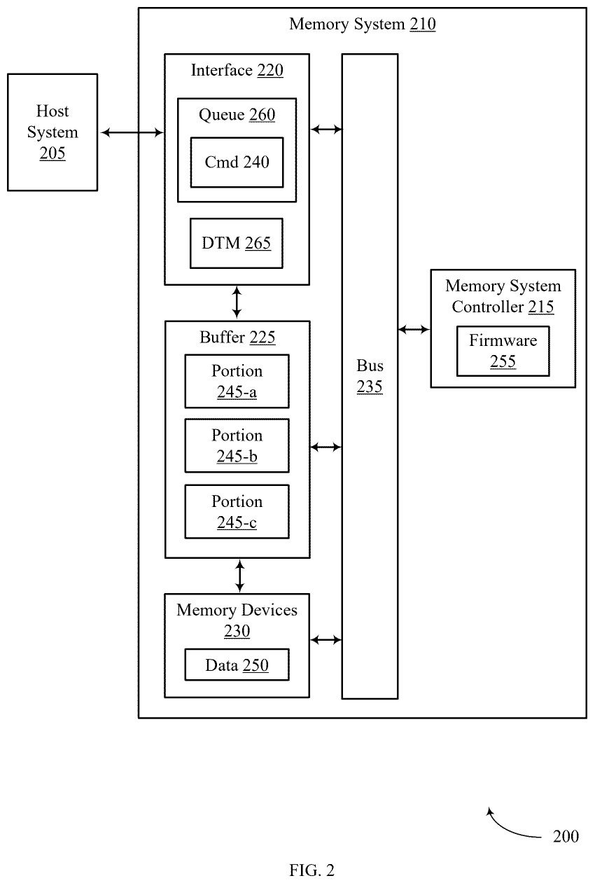

FIG. 2 shows an example of a system 200 that supports a pre-read algorithm for a sequential read operation of a memory system in accordance with examples as disclosed herein. In some examples, the system 200 may support aspects of a system 100. For example, the system 200 may include a host system 205, a memory system 210, memory devices 230, and a memory system controller 215, which may be examples of a host system 105, a memory system 110, memory devices 130, and a memory system controller 115 as described with reference to FIG. 1, respectively.

In some examples, the memory system 210 may communicate with the host system 205 via an interface 220. As shown in FIG. 2, the interface 220 may include a queue 260. If the host system 205 sends a command 240 to the memory system 210, the memory system 210 may store the command 240 in the queue 260. In some examples, the queue 260 may have a queue depth of one. In such example, the queue 260 may store the command 240 and wait until the command 240 is executed by the memory system 210 before a new command 240 can be stored in the queue 260. A time between removing the command 240 from the queue 260 and adding the new command 240 to the queue 260 may be known as an idle window.

In some examples, the host system 205 and the memory system 210 may perform a sequential read operation. During the sequential read operation, the host system 205 may transmit commands 240 to the memory system 210 that instruct the memory system 210 to read sequential data 250 from memory devices 230. In some examples, sequential data 250 may refer to data stored at consecutive memory addresses of the memory devices 230. As an example, the host system 205 may transmit a first command 240 that instructs the memory system 210 to read a first portion of the sequential data 250 from the memory devices 230 and additionally, the host system 205 may transmit a second command 240 that instructs the memory system 210 to read a second portion of the sequential data 250 from the memory devices 230.

In some examples, the memory system 210 may identify that a command 240 received from the host system 205 is associated with the sequential read operation and perform a pre-read operation during an idle window that follows the execution of the command 240. For example, the memory system 210 may receive the first command 240 and store the first command 240 in the queue 260. Further, the memory system controller 215 may execute the first command 240 or more specifically, the memory system controller 215 may read the first portion of the sequential data 250 from the memory devices 230 and transmit the first portion of the sequential data 250 to the host system 205 via the interface 220.

Upon executing the first command 240, the memory system 210 may enter an idle window and preform a pre-read operation during the idle window and in response to identifying that the first command 240 corresponds to a sequential read operation. During the pre-read operation, the memory system controller 215 (or the firmware 255) may transmit a pre-read command to the memory devices 230 instructing the memory devices 230 (or a controller of the memory devices 230) to retrieve the sequential data 250 and store the sequential data 250 in a buffer 225 (e.g., a 576 KB buffer) of the memory system 210.

In some examples, the firmware 255 may divide the buffer 225 into multiple portions 245 (e.g., eight 64 KB portions). For example, the firmware 255 may divide the buffer 225 into at least a portion 245-a, a portion 245-b, and a portion 245-c. Further, the firmware 255 may enable (e.g., via bus 235) a data transfer module (DTM) 265 to monitor a status of the data being transferred between the memory devices 230 and each of the portions 245. For example, the DTM 265 may monitor a quantity of the sequential data 250 that is moved from the memory devices 230 to each of the portion 245-a, the portion 245-b, and the portion 245-c. In some examples, the DTM 265 may be located within the interface 220 or may be coupled with the interface 220.

In some examples, if the firmware 255 identifies, via the DTM 265, that a portion 245 is full (e.g., a threshold quantity of sequential data 250 has been transferred from the memory devices 230 to the portion 245), the firmware 255 may set a flag associated with the portion 245 to a first value, where the first value indicates that the respective portion 245 is full. For example, the firmware 255 may set a flag corresponding to the portion 245-a to the first value if a second portion of the sequential data 250 (e.g., 64 KBs of the sequential data 250) is transferred from the memory devices 230 to the portion 245-a.

After the idle window expires, the memory system 210 may receive a second command 240 from the host system 205 and store the second command 240 in the queue 260. Upon receiving the second command 240, the firmware 255 may identify that the second command 240 corresponds to the sequential read operation and further identify that the second command 240 instructs the memory system 210 to read the second portion of the sequential data 250 (or identify that the second command hit the portion 245-a of the buffer 225). Upon identifying such attributes of the second command 240, the memory system controller 215 may transmit signaling (e.g., a DTM request) to the interface 220 requesting that the interface 220 transfer the second portion of the sequential data 250 stored in the portion 245-a to the host system 205.

Upon receiving the signaling, the interface 220 may determine whether the second portion of the sequential data 250 is ready to be transferred to the host system 205 (e.g., the portion 245-a is full) and based on or in response to determining that the second portion of the sequential data 250 is ready to be transferred, transfer the second portion of the sequential data 250 to the host system 205. In some examples, the interface 220 may determine whether (e.g., that) the second portion of the sequential data is ready for transfer through the DTM 265 or the first value of the flag corresponding to the portion 245-a. Using such methods, the firmware 255 may not activate a read task associated with the second command. Instead, the firmware 255 may identify that the second command 240 corresponds to the portion 245-a as soon as the second command is moved from the queue 260 to a software queue of the memory system 210 which may reduce latency if compared to performing the read task.

In some examples, the firmware 255 may allocate some of the portions 245 for the pre-read data (e.g., the sequential data 250) and some of the portions 245 for other data. For example, the firmware 255 may allocate the portion 245-a and the portion 245-b for the pre-read data and the portion 245-c for other data. This may allow the memory system 210 to process other read commands (e.g., random read commands or read buffer commands) in between sequential read commands without dropping pre-read data (e.g., sequential data 250) in the buffer 225.

As an example, after the idle window following the first command 240 and prior to receiving the second command 240, the memory system 210 may receive a third command 240 and store the third command in the queue 260. In some examples, the memory system 210 may identify that the third command 240 does not correspond to the sequential read operation and includes a random read command that instructs the memory system 210 to read other data (e.g., data different from the sequential data 250) from the memory devices 230. In such example, the memory system controller 215 may enable the memory devices 230 to transfer the other data to the portion 245-c of the buffer 225 such that the buffer 225 includes at least the second portion of the sequential data (e.g., in the portion 245-a) and the other data (e.g., in the portion 245-c). Further, the memory system controller 215 may enable the interface 220 to transfer the other data from the portion 245-c to the host system 205.

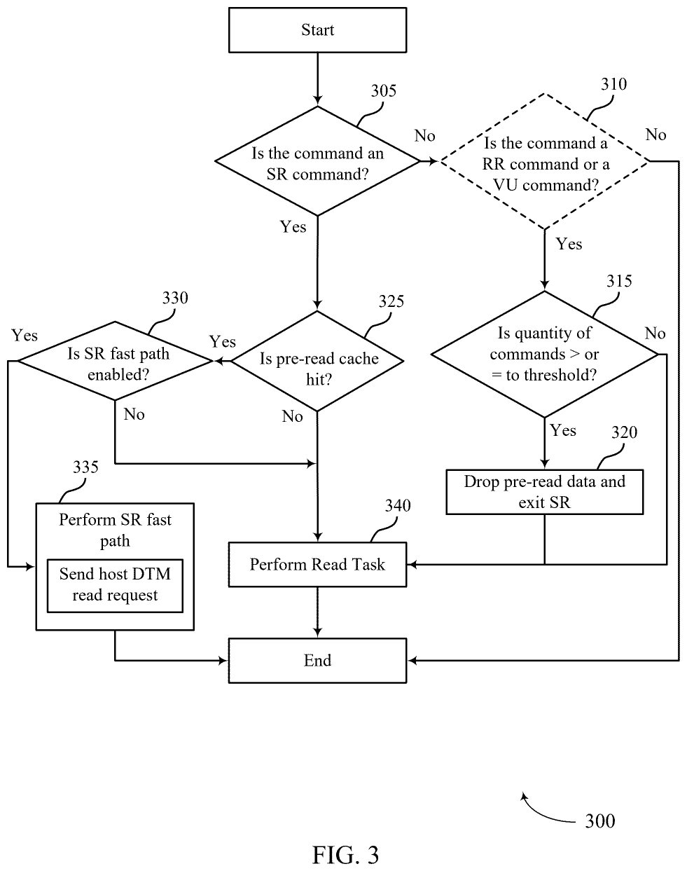

FIG. 3 shows an example of a flow diagram 300 that supports a pre-read algorithm for a sequential read operation of a memory system in accordance with examples as disclosed herein. In some examples, the flow diagram 300 may be implemented by aspects of the system 100 or the system 200. For example, the flow diagram 300 may be implemented by a memory system 110 or a memory system 210 as described with reference to FIGS. 1 and 2, respectively.

At 305, a first command is received and it is determined whether the first command corresponds to or is part of a sequential read operation. For example, the memory system (e.g., a controller of the memory system) may determine whether the first command includes a sequential read command. If the first command includes a sequential read command, the memory system may proceed to 325. Alternatively, if the first command does not include a sequential read command. the memory system may proceed to 310.

At 310, it is potentially determined whether the first command is a read buffer command (or a VU command) or a random read command (or a RR command). For example, the memory system (e.g., the controller of the memory system) may determine whether the first command is a read buffer command or a random read command. If the first command includes a random read command or a read buffer command, the memory system may proceed to 315.

At 315, a value of a counter is adjusted (e.g., incremented) and it is determined whether the value of the counter exceeds or is equal to a threshold. For example, the memory system may adjust (e.g., increment) the counter for each consecutive random read command or read buffer command received by the memory system and determine whether the value of the counter exceeds or is equal to the threshold. In some examples, the threshold may be equal to six consecutive random read commands or read buffer commands. If the counter exceeds or is equal to the threshold, the memory system may proceed to 320. If the counter does not exceed or is not equal to the threshold, the memory system may proceed to 340.

At 320, data (e.g., pre-read data or sequential read data) stored in a buffer of the memory system may be dropped and active sequential read operations may end. For example, the memory system may drop sequential read data from the buffer and end an active sequential read operation corresponding to the sequential read data. In some examples, multiple consecutive random read commands or read buffer commands may indicate that a sequential read operation has ended or that the sequential read data in the buffer is stale. Upon dropping the data stored in the buffer and/or ending the active sequential read operation, the memory system may proceed to 340.

At 325, it is determined whether at least portion of the buffer of the memory system has been hit. For example, the memory system (e.g., or a controller of the memory system) may determine whether the first command corresponds to sequential data stored in the at least one portion of the buffer. If the at least portion of the buffer is hit, the memory system may proceed to 330. If the at least portion of the buffer is not hit, the memory system may proceed to 340.

At 330, it is determined whether a sequential read fast path function of the memory system is enabled. For example, the memory system may determine if the sequential read fast path function is enabled. If sequential read fast path is enabled, the memory system may proceed to 335. If the sequential read fast path is disabled, the memory system may proceed to 340.

At 335, sequential read fast path is performed. For example, the memory system may perform sequential read fast path. To perform sequential read fast path, a controller of the memory system may send a host DTM read request to an interface of the memory system that is coupled with the host system. The DTM read request may include a request for the interface to transmit the sequential data stored in the at least portion of the buffer to be transmitted to the host system. Upon receiving the DTM request, the interface may monitor the readiness of the sequential data and transfer the sequential data to the host system upon identifying the sequential data is ready for transfer. In some examples, the interface may determine the sequential data is ready if the interface identifies (e.g., via a DTM manager) that the sequential data associated with the first command has been fully transferred from the memory devices of the memory system to the at least portion of the buffer. Using such methods, the memory system may avoid activating a read task for the first command which may reduce latency if compared to other methods.

At 340, a read task associated with the first command may be performed. In some examples, the first command may include a random read command or a read buffer command. In such example, the memory system may perform a read task associated with the random read command or the read buffer command which may include reading data corresponding to the first command from one or more memory devices of the memory system and transferring the data to the host system.

In another example, the first command may include a sequential read command, but no sequential read data associated with the first command has been stored into the buffer (e.g., via a pre-read operation). In such case, performing the read task associated with the first command may include the memory system reading data corresponding to the first command from the one or more memory devices of the memory system and transferring the data to the host system.

In another example, the first command may include a sequential read command and the at least portion of the buffer may be hit, but the sequential read fast path function may be disabled. In such example, the memory system may enter a read task associated with the first command even if the sequential data associated with the first command is already stored in the buffer. In such example, the controller of the memory system may transmit the host DTM read request to the interface after initiating the read task for the first command and the interface may transfer the sequential data corresponding to the first command from the buffer to the host system.

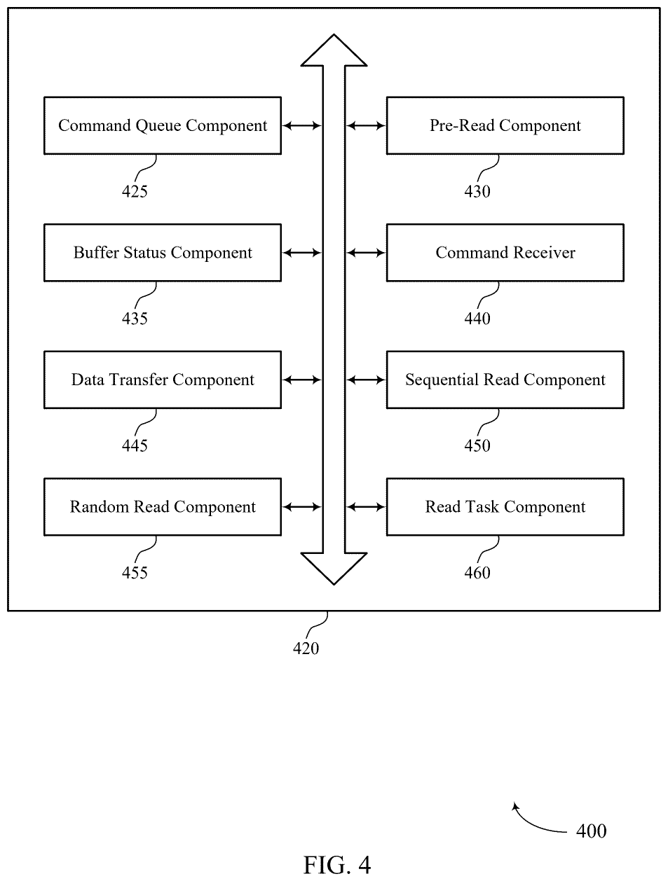

FIG. 4 shows a block diagram 400 of a memory system 420 that supports a pre-read algorithm for a sequential read operation of a memory system in accordance with examples as disclosed herein. The memory system 420 may be an example of aspects of a memory system as described with reference to FIGS. 1 through 3. The memory system 420, or various components thereof, may be an example of means for performing various aspects of a pre-read algorithm for a sequential read operation of a memory system as described herein. For example, the memory system 420 may include a command queue component 425, a pre-read component 430, a buffer status component 435, a command receiver 440, a data transfer component 445, a sequential read component 450, a random read component 455, a read task component 460, or any combination thereof. Each of these components, or components of subcomponents thereof (e.g., one or more processors, one or more memories), may communicate, directly or indirectly, with one another (e.g., via one or more buses).

The command queue component 425 may be configured as or otherwise support a means for storing a first command in a command queue, the first command indicating to read a first set of data from at least one of one or more memory devices of the memory system. The pre-read component 430 may be configured as or otherwise support a means for transmitting, based at least in part on executing the first command, a second command to read a second set of data from at least one of the one or more memory devices. In some examples, the pre-read component 430 may be configured as or otherwise support a means for storing the second set of data in a buffer of the memory system based at least in part on receiving the second set of data, where the buffer includes a plurality of portions and at least a subset of the second set of data is stored in a first portion of the plurality of portions. The buffer status component 435 may be configured as or otherwise support a means for setting a value of a flag associated with the first portion based at least in part on storing the at least subset of the second set of data in the first portion, the value of the flag indicating that the at least subset of the second set of data has been transferred to the first portion. The command receiver 440 may be configured as or otherwise support a means for receiving, after setting the value of the flag, a third command to read the at least subset of the second set of data. The data transfer component 445 may be configured as or otherwise support a means for transmitting the subset of the second set of data based at least in part on the third command and the value of the flag.

In some examples, the sequential read component 450 may be configured as or otherwise support a means for determining whether the third command corresponds to a first type of command, the first type of command including a sequential read command, where transmitting the subset of the second set of data is based at least in part on determining that the third command corresponds to the first type of command.

In some examples, the pre-read component 430 may be configured as or otherwise support a means for determining whether the third command includes a read command for the at least subset of the second set of data, where transmitting the at least subset of the second set of data is based at least in part on determining that the third command includes the read command.

In some examples, the command queue component 425 may be configured as or otherwise support a means for storing, after executing the first command, a fourth command in the command queue. In some examples, the random read component 455 may be configured as or otherwise support a means for determining whether the fourth command corresponds to a second type of command different from a first type of command that includes a sequential read command. In some examples, the random read component 455 may be configured as or otherwise support a means for adjusting (e.g., incrementing) a counter based at least in part on determining that the fourth command corresponds to the second type of command, where transmitting the at least subset of the second set of data is based at least in part on determining that the value of the counter does not satisfy a threshold.

In some examples, the second type of command includes a random read command or a read buffer command. In some examples, the random read component 455 may be configured as or otherwise support a means for storing, based at least in part on the fourth command, a third set of data corresponding to the fourth command in at least a second portion of the plurality of portions of the buffer.

In some examples, the read task component 460 may be configured as or otherwise support a means for refraining from performing a read task corresponding to the third command based at least in part on determining that the third command corresponds to the at least subset of the second set of data and the value of the flag.

In some examples, the data transfer component 445 may be configured as or otherwise support a means for communicating a host read DTM request to an interface between the memory system and a host system, where identifying the value of the flag is based at least in part on the host read DTM request. In some examples, a queue depth associated with the command queue is equal to one.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

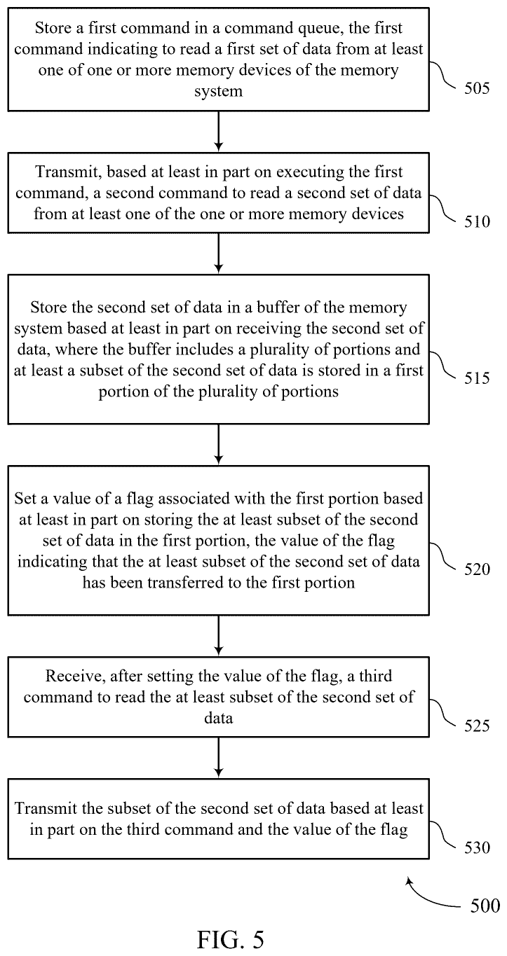

FIG. 5 shows a flowchart illustrating a process 500 that supports a pre-read algorithm for a sequential read operation of a memory system in accordance with examples as disclosed herein. The operations of process 500 may be implemented by a memory system or its components as described herein. For example, the operations of process 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include storing a first command in a command queue, the first command indicating to read a first set of data from at least one of one or more memory devices of the memory system. In some examples, aspects of the operations of 505 may be performed by a command queue component 425 as described with reference to FIG. 4.

At 510, the method may include transmitting, based at least in part on executing the first command, a second command to read a second set of data from at least one of the one or more memory devices. In some examples, aspects of the operations of 510 may be performed by a pre-read component 430 as described with reference to FIG. 4.

At 515, the method may include storing the second set of data in a buffer of the memory system based at least in part on receiving the second set of data, where the buffer includes a plurality of portions and at least a subset of the second set of data is stored in a first portion of the plurality of portions. In some examples, aspects of the operations of 515 may be performed by a pre-read component 430 as described with reference to FIG. 4.

At 520, the method may include setting a value of a flag associated with the first portion based at least in part on storing the at least subset of the second set of data in the first portion, the value of the flag indicating that the at least subset of the second set of data has been transferred to the first portion. In some examples, aspects of the operations of 520 may be performed by a buffer status component 435 as described with reference to FIG. 4.

At 525, the method may include receiving, after setting the value of the flag, a third command to read the at least subset of the second set of data. In some examples, aspects of the operations of 525 may be performed by a command receiver 440 as described with reference to FIG. 4.

At 530, the method may include transmitting the subset of the second set of data based at least in part on the third command and the value of the flag. In some examples, aspects of the operations of 530 may be performed by a data transfer component 445 as described with reference to FIG. 4.

In some examples, an apparatus as described herein may perform a method or methods, such as the process 500. The apparatus may include operations, features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for storing a first command in a command queue, the first command indicating to read a first set of data from at least one of one or more memory devices of the memory system; transmitting, based at least in part on executing the first command, a second command to read a second set of data from at least one of the one or more memory devices; storing the second set of data in a buffer of the memory system based at least in part on receiving the second set of data, where the buffer includes a plurality of portions and at least a subset of the second set of data is stored in a first portion of the plurality of portions; setting a value of a flag associated with the first portion based at least in part on storing the at least subset of the second set of data in the first portion, the value of the flag indicating that the at least subset of the second set of data has been transferred to the first portion; receiving, after setting the value of the flag, a third command to read the at least subset of the second set of data; and transmitting the subset of the second set of data based at least in part on the third command and the value of the flag.

Aspect 2: The method, apparatus, or non-transitory computer-readable medium of aspect 1, further including operations, features, circuitry, logic, means, or instructions, or any combination thereof for determining whether the third command corresponds to a first type of command, the first type of command including a sequential read command, where transmitting the subset of the second set of data is based at least in part on determining that the third command corresponds to the first type of command.

Aspect 3: The method, apparatus, or non-transitory computer-readable medium of any of aspects 1 through 2, further including operations, features, circuitry, logic, means, or instructions, or any combination thereof for determining whether the third command includes a read command for the at least subset of the second set of data, where transmitting the at least subset of the second set of data is based at least in part on determining that the third command includes the read command.

Aspect 4: The method, apparatus, or non-transitory computer-readable medium of any of aspects 1 through 3, further including operations, features, circuitry, logic, means, or instructions, or any combination thereof for storing, after executing the first command, a fourth command in the command queue; determining whether the fourth command corresponds to a second type of command different from a first type of command that includes a sequential read command; and adjusting (e.g., incrementing) a counter based at least in part on determining that the fourth command corresponds to the second type of command, where transmitting the at least subset of the second set of data is based at least in part on determining that the value of the counter does not satisfy a threshold.

Aspect 5: The method, apparatus, or non-transitory computer-readable medium of aspect 4, where the second type of command includes a random read command or a read buffer command.

Aspect 6: The method, apparatus, or non-transitory computer-readable medium of any of aspects 4 through 5, further including operations, features, circuitry, logic, means, or instructions, or any combination thereof for storing, based at least in part on the fourth command, a third set of data corresponding to the fourth command in at least a second portion of the plurality of portions of the buffer.

Aspect 7: The method, apparatus, or non-transitory computer-readable medium of any of aspects 1 through 6, further including operations, features, circuitry, logic, means, or instructions, or any combination thereof for refraining from performing a read task corresponding to the third command based at least in part on determining that the third command corresponds to the at least subset of the second set of data and the value of the flag.

Aspect 8: The method, apparatus, or non-transitory computer-readable medium of any of aspects 1 through 7, further including operations, features, circuitry, logic, means, or instructions, or any combination thereof for communicating a host read DTM request to an interface between the memory system and a host system, where identifying the value of the flag is based at least in part on the host read DTM request.

Aspect 9: The method, apparatus, or non-transitory computer-readable medium of any of aspects 1 through 8, where a queue depth associated with the command queue is equal to one.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
store a first command in a command queue, the first command indicating to read a first set of data from at least one of the one or more memory devices of the memory system;
transmit, based at least in part on executing the first command, a second command to read a second set of data from at least one of the one or more memory devices;
store the second set of data in a buffer of the memory system based at least in part on receiving the second set of data, wherein the buffer comprises a plurality of portions and at least a subset of the second set of data is stored in a first portion of the plurality of portions;
set a value of a flag associated with the first portion based at least in part on storing the at least subset of the second set of data in the first portion, the value of the flag indicating that the at least subset of the second set of data has been transferred to the first portion;
receive, after setting the value of the flag, a third command to read the at least subset of the second set of data; and
transmit the subset of the second set of data based at least in part on the third command and the value of the flag.

2. The memory system of claim 1, wherein the processing circuitry is further configured to cause the memory system to:
determine whether the third command corresponds to a first type of command, the first type of command comprising a sequential read command, wherein transmitting the subset of the second set of data is based at least in part on determining that the third command corresponds to the first type of command.

3. The memory system of claim 1, wherein the processing circuitry is further configured to cause the memory system to:
determine whether the third command comprises a read command for the at least subset of the second set of data, wherein transmitting the at least subset of the second set of data is based at least in part on determining that the third command comprises the read command.

4. The memory system of claim 1, wherein the processing circuitry is further configured to cause the memory system to:
store, after executing the first command, a fourth command in the command queue;
determine whether the fourth command corresponds to a second type of command different from a first type of command that comprises a sequential read command; and
increment a counter based at least in part on determining that the fourth command corresponds to the second type of command, wherein transmitting the at least subset of the second set of data is based at least in part on determining that the value of the counter does not satisfy a threshold.

5. The memory system of claim 4, wherein the second type of command comprises a random read command or a read buffer command.

6. The memory system of claim 4, wherein the processing circuitry is further configured to cause the memory system to:
store, based at least in part on the fourth command, a third set of data corresponding to the fourth command in at least a second portion of the plurality of portions of the buffer.

7. The memory system of claim 1, wherein the processing circuitry is further configured to cause the memory system to:
refrain from performing a read task corresponding to the third command based at least in part on determining that the third command corresponds to the at least subset of the second set of data and the value of the flag.

8. The memory system of claim 1, wherein the processing circuitry is further configured to cause the memory system to:
communicate a host read data transfer module request to an interface between the memory system and a host system, wherein identifying the value of the flag is based at least in part on the host read data transfer module request.

9. The memory system of claim 1, wherein a queue depth associated with the command queue is equal to one.

10. The memory system of claim 1, wherein each portion of the plurality of portions are configured to store 64 kilobytes of data.

11. A non-transitory computer-readable medium storing code, the code comprising instructions executable by one or more processors to:
store a first command in a command queue, the first command indicating to read a first set of data from at least one of one or more memory devices of a memory system;
transmit, based at least in part on executing the first command, a second command to read a second set of data from at least one of the one or more memory devices;
store the second set of data in a buffer of the memory system based at least in part on receiving the second set of data, wherein the buffer comprises a plurality of portions and at least a subset of the second set of data is stored in a first portion of the plurality of portions;
set a value of a flag associated with the first portion based at least in part on storing the at least subset of the second set of data in the first portion, the value of the flag indicating that the at least subset of the second set of data has been transferred to the first portion;
receive, after setting the value of the flag, a third command to read the at least subset of the second set of data; and
transmit the subset of the second set of data based at least in part on the third command and the value of the flag.

12. The non-transitory computer-readable medium of claim 11, wherein the instructions are further executable by the one or more processors to:
determine whether the third command corresponds to a first type of command, the first type of command comprising a sequential read command, wherein transmitting the subset of the second set of data is based at least in part on determining that the third command corresponds to the first type of command.

13. The non-transitory computer-readable medium of claim 11, wherein the instructions are further executable by the one or more processors to:
determine whether the third command comprises a read command for the at least subset of the second set of data, wherein transmitting the at least subset of the second set of data is based at least in part on determining that the third command comprises the read command.

14. The non-transitory computer-readable medium of claim 11, wherein the instructions are further executable by the one or more processors to:
store, after executing the first command, a fourth command in the command queue;
determine whether the fourth command corresponds to a second type of command different from a first type of command that comprises a sequential read command; and
increment a counter based at least in part on determining that the fourth command corresponds to the second type of command, wherein transmitting the at least subset of the second set of data is based at least in part on determining that the value of the counter does not satisfy a threshold.

15. The non-transitory computer-readable medium of claim 14, wherein the instructions are further executable by the one or more processors to:
store, based at least in part on the fourth command, a third set of data corresponding to the fourth command in at least a second portion of the plurality of portions of the buffer.

16. The non-transitory computer-readable medium of claim 11, wherein the instructions are further executable by the one or more processors to:
refrain from performing a read task corresponding to the third command based at least in part on determining that the third command corresponds to the at least subset of the second set of data and the value of the flag.

17. The non-transitory computer-readable medium of claim 11, wherein the instructions are further executable by the one or more processors to:
communicate a host read data transfer module request to an interface between the memory system and a host system, wherein identifying the value of the flag is based at least in part on the host read data transfer module request.

18. A method by a memory system, comprising:
storing a first command in a command queue, the first command indicating to read a first set of data from at least one of one or more memory devices of the memory system;
transmitting, based at least in part on executing the first command, a second command to read a second set of data from at least one of the one or more memory devices;
storing the second set of data in a buffer of the memory system based at least in part on receiving the second set of data, wherein the buffer comprises a plurality of portions and at least a subset of the second set of data is stored in a first portion of the plurality of portions;
setting a value of a flag associated with the first portion based at least in part on storing the at least subset of the second set of data in the first portion, the value of the flag indicating that the at least subset of the second set of data has been transferred to the first portion;
receiving, after setting the value of the flag, a third command to read the at least subset of the second set of data; and
transmitting the subset of the second set of data based at least in part on the third command and the value of the flag.

19. The method of claim 18, further comprising:
determining whether the third command corresponds to a first type of command, the first type of command comprising a sequential read command, wherein transmitting the subset of the second set of data is based at least in part on determining that the third command corresponds to the first type of command.

20. The method of claim 18, further comprising:
determining whether the third command comprises a read command for the at least subset of the second set of data, wherein transmitting the at least subset of the second set of data is based at least in part on determining that the third command comprises the read command.
